(19) United States
(12) Patent Application Publication
(10) Pub. No.: US 2009/0057592 A1
(43) Pub. Date: Mar. 5, 2009

(54) FLOW CONTROL AND CLOSURE VALVE WITH AXIAL FLOW IN THE VALVE ELEMENT

(76) Inventors: Haresh C. Lakhan, Eagan, MN (US); Bruce A. Helget, Hutchinson, MN (US); Daniel J. Smith, Lakeville, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/845,884

(22) Filed: Aug. 28, 2007

(51) Int. Cl. F16K 1/00

(52) U.S. Cl. 251/318

(57) ABSTRACT

A metering valve for controlling the flow rate of a fluid has a substantially rigid housing having an internal cylindrical wall defining a cavity. The cavity has a first opening at one end and a spaced second opening in the cylindrical wall. A substantially rigid valve element that fits closely within the cavity has an internal bore extending axially from a first end toward a second end. A metering aperture penetrates the valve element wall between the outer surface of the valve element and the valve element bore. Moving the valve element within the housing cavity to a first position places a portion of the second opening within the cavity's second opening at a first position to allow a first rate of fluid flow between the first chamber and the second chamber. Moving the valve element to a second position places the metering aperture at a second position different from the first position to allow a second rate of fluid flow between the first and second chambers. The flow has an axial flow vector within the valve element bore and a radial flow vector through the metering aperture.

### BACKGROUND OF THE INVENTION

Valves for control of fluid flow have a variety of designs. Many include both flow rate and shutoff functions. For example, the common residential water faucet typically has a threaded stem controlling the position of a valve element, usually including a rubber washer for sealing flow of water. Rotating the stem with the handle in one direction presses the valve element's washer against a seat to shut off water flow. Rotating the stem in the opposite direction lifts the washer from the seat and allows control of the flow rate.

Ball and gate valves are other types of valves that combine flow control and shutoff functions.

Each of these valves has advantages and disadvantages. Threaded stem valves require a multi-turn rotary actuator but give quite precise flow control and secure shutoff. As any homeowner knows however, the sealing washers on these valves require regular replacement. Ball and gate valves can be operated with a rotary actuator but provide relatively coarse flow control.

A valve operable by a short stroke linear actuator and that has relatively precise flow control has many advantages. Such a valve that can also provide secure shutoff is even more desirable.

### BRIEF DESCRIPTION OF THE INVENTION

A metering valve for controlling the flow rate of a fluid has a housing having an internal cylindrical wall defining a cavity. The cavity has a first opening at one end and a spaced second opening in the cylindrical wall and comprising a flow space. The flow space is defined at least in part by an edge.

A substantially rigid valve element has an outer surface that fits closely within the cavity to oppose leakage between the cavity and the valve element. The valve element has an internal bore extending axially from a first end toward a second end and with the valve element outer surface, defining a wall. A metering aperture penetrates the valve element wall between the outer surface of the valve element and the valve element bore.

The valve element can be shifted within the housing cavity to a first position placing a portion of the flow space edge within the metering gap at a first position to align a portion of the metering aperture with a portion of the flow space to allow a first rate of fluid flow between the first chamber and the second chamber. Sliding the valve element to a second position places the metering aperture at a second position different from the first position to allow a second rate of fluid flow between the first and second chambers. The flow has an axial flow vector within the valve element bore and a radial flow vector through the metering aperture.

The flow space edge may be between the first and second openings, or one of the openings itself may form the edge.

In one embodiment, the valve the valve element has a sealing element engaging a passage opening when the valve element is in a third position, to close off the passage opening, and thereby close the valve to fluid flow.

In another embodiment, the valve element includes a diaphragm having a center sealingly attached to an end of the valve element and a periphery sealingly attached to the housing. The diaphragm defines a portion of the chamber to prevent fluid flow from the valve except through one of the ports, or to prevent flow between the ports except through the valve itself.

Still other embodiments have various shapes for the metering aperture. Some of these metering apertures may comprise a series of adjacent holes or gaps in the valve element wall.

### BRIEF DESCRIPTION OF THE DRAWINGS

FIG. 1 shows a perspective view of a control element of a valve.

FIG. 2 is a cross section view of the control element of the valve.

FIGS. 3 and 4 are cross section view of the valve with the control element in closed and open positions respectively.

FIGS. 5 and 6 show a cross section view of a commercial embodiment of a valve incorporating the invention in closed and in partially opened states.

FIG. 7 is a cross section view of a first alternative embodiment of the valve shown in FIGS. 5 and 6.

FIG. 8 is a perspective view of a first alternative to the embodiment of the valve element shown in FIG. 1.

FIG. 9 is a perspective view of a second alternative to the embodiment of the valve element shown in FIG. 1.

FIG. 10 is a perspective view of a third alternative to the embodiment of the valve element shown in FIG. 1.

FIG. 11 is a cross section view of a fourth alternative embodiment similar to the valve element shown in FIG. 1.

FIG. 12 is perspective view of a fifth alternative embodiment similar to the valve element shown in FIG. 1.

FIG. 13 is a cross section view of the valve element shown in FIG. 12.

FIG. 14 is a cross section view of an alternative embodiment of the valve element shown in FIGS. 12 and 13.

### DETAILED DESCRIPTION OF THE EMBODIMENTS

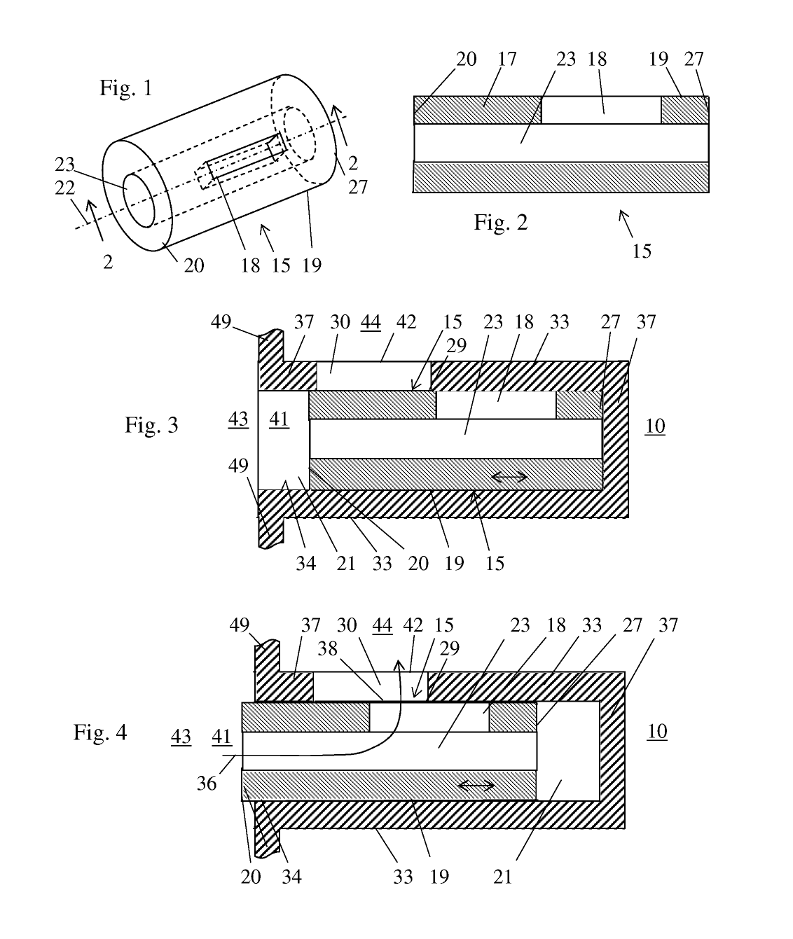

FIGS. 1 and 2 show a first embodiment of a substantially rigid valve element 15 suitable for use in a valve unit 10 embodying the invention to allow precise control of fluid flow rate. Valve element 15 has first and second end surfaces 20 and 27 aligned along an axis, and a generally cylindrical outer surface 19 extending between end surfaces 20 and 27. In a typical embodiment, surface 19 is circularly cylindrical. Valve element 15 has a bore 23 extending axially from the first end surface 20 to the second end surface 27. Bore 23 and surface 19 define between them a tubular wall 17.

An aperture or slot 18 in wall 17 extends axially for a selected distance between and spaced from end surfaces 20 and 27. Aperture 18 extends radially between the outer surface 19 and bore 23 to allow fluid to flow between bore 23 and areas surrounding surface 19. “Axially” for these features of valve element 15 has the conventional meaning of extending along the axis 22 of the cylindrical outer surface 19. Aperture 18 should form a passage large enough to allow the maximum desired amount of fluid flow. While a single aperture 18 is shown in FIGS. 1-4, multiple apertures are also possible and will be disclosed below.

The cross section view in FIGS. 3 and 4 shows valve unit 10 with valve element 15 incorporated. FIG. 3 shows valve 10 when closed, and FIG. 4 shows valve 15 when partially open.

The valve unit 10 has a generally rigid housing 37 with a cylindrical bore or cavity 21 shown partially occupied in FIGS. 3 and 4 by a valve element 15 whose dimensions are compatible with housing 37. Cavity 21 is defined by a wall 33 having an annular inner surface 34, and which forms a part of housing 37. Cavity 21 will usually have a circularly cylindrical cross section, but other cylindrical cross sections may be advantageous for some applications. The open end of cavity 21 forms a first port 41 serving in this embodiment as an inlet port.

Valve unit 10 has an inlet chamber generally designated at 43. An outlet chamber of valve unit 10 is generally designated at 44. A wall 49 of which only a small portion is shown, physically separates an inlet chamber shown at 43 and an outlet chamber shown at 44 so that no fluid can flow between them except through cavity 21 and valve element 15.

In the valve unit 10 embodiment, outer surface 19 of valve element 15 fits closely within cavity 21 and can slide within cavity 21 to any of a variety of axial positions as shown by the double-ended arrow. “Fits closely” means that the outer surface 19 has a shape and dimensions that forms a sealing interface with the inner surface 34 allowing a little fluid at most to leak between surfaces 19 and 34. The surfaces 19 and 34 may fit so tightly with each other that no fluid leakage occurs. Alternatively, the design may incorporate sealing elements such as O-rings between surfaces 19 and 34 to oppose or prevent fluid leakage. A surface 19 in designs using such sealing elements also is considered to “fit closely” within cavity 21.

In another embodiment, surfaces 19 and 34 may be deliberately formed with a small gap between them to allow flow or leakage of some fluid between surfaces 19 and 34. Such a gap provides a limited flow of fluid through valve 10 regardless of the position of valve element 15, and will be discussed in more detail later.

An opening or window 30 spaced from the open end of cavity 21 penetrates annular wall 33 to cavity 21. Opening 30 extends through wall 33 to allow flow through wall 33 from cavity 21. Opening 30 has an edge or corner 29 at one axial extreme. The external opening 30 forms in this embodiment, a second port 42 serving as an outlet port. Opening 30 should extend axially for a predetermined distance and have an angular width sufficient to allow the maximum desired amount of fluid flow. In this embodiment, aperture 18 should be held in substantial angular alignment with opening 30.

FIG. 4 indicates fluid flow by an arrow 36 entering bore 23 axially from first port 41. As can be seen, the direction of fluid flow then changes approximately 90° to radial flow. Port 41 is shown as the inlet port in this embodiment, but in fact either of port 41 or port 42 may serve as the inlet port with the other serving as the outlet port.

FIGS. 3 and 4 show valve element 15 in two different positions within cavity 21. Positioning aperture 18 with respect to edge 29 to form an overlap relation with opening 30 as shown in FIG. 4 creates an orifice at 38 through which fluid can flow. The size of this orifice 38 can be varied by changing the axial position of valve element 15 within cavity 21. The two-headed arrows in FIGS. 3 and 4 indicate that valve element 15 can shift axially within cavity 21 to control or alter the fraction of aperture 18 occluded by facing wall 34. The size of the orifice 38 formed by the overlap of gap 30 and metering aperture 18 controls the flow rate of fluid through valve 10.

FIGS. 3 and 4 do not show the positioning mechanism for valve element 15. A variety of positioning means are possible. For example, a mechanical link may be attached to valve element 15 at the second end surface 27 and project rightwardly through an aperture (not shown) in housing 37 to outside of housing 37. A seal mechanism between the mechanical link and housing 37 opposes fluid leaks from cavity 21. A linear actuator or other control may apply force to valve element 15 through this link to position valve element 15 in any desired position and control fluid flow with precision and repeatability.

The position of valve element 15 shown in FIG. 3 corresponds to closing valve 10. In structures where the seal created between valve element 15 and passage 21 is adequate to prevent any fluid leakage, the position of valve element 15 in FIG. 3 is adequate by itself to allow shutoff of fluid flow.

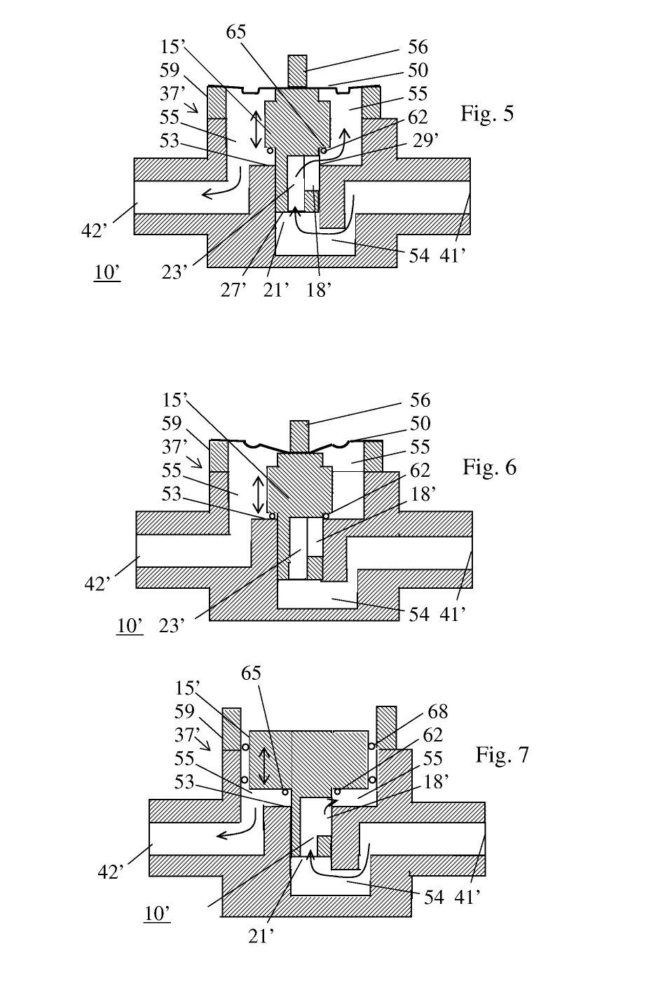

FIGS. 5 and 6 show a flow control valve 10′ that forms a variant of the flow control valve 10. Reference numbers for components and features of valve 10′ in FIGS. 5-7 that are analogous to various components and features of valve 10 have similar numeric portions.

Valve 10′ includes a rigid housing 37′ having first and second ports 41′ and 42′. Fluid flows into one of ports 41′ and 42′ and flows out of the other. Arrows in FIG. 5 show one path of fluid flow.

Housing 37′ has an inlet chamber 54 in fluid communication with port 41′ and an outlet chamber 55 in fluid communication with port 42′. Outlet chamber 55 is defined in part by walls of housing 37′, partly by a cap 59, and partly by a diaphragm 50. Cap 59 attaches to a top surface of housing 37′ by means not shown but which are simple for someone with skill in these arts to devise. Diaphragm 50 is peripherally attached to a top surface of cap 59. The attachments between cap 59 and housing 37′ and between diaphragm 50 and housing 37′ seals against escape of any fluid within chamber 55. Alternatives for attaching diaphragm 50 to cap 59 are possible and easy for someone with skill in the art to devise.

Housing 37′ also has an internal cavity 21′ that connects chamber 54 with chamber 55. Cavity 21′ should be cylindrical and typically will be circularly cylindrical. An annular edge 29′ defines the upper end of cavity 21′. A sealing surface 53 is radially outboard of edge 29′.

The rigid valve element 15′ in FIGS. 5 and 6 is functionally similar to valve element 15 shown in FIGS. 1-4, with a bore 23′ and an aperture 18′ such as a slot providing fluid communication from bore 23 to the area exterior to valve element 15′. In the embodiment of FIGS. 5 and 6, a portion of valve element 15′ is external to cavity 21′, and bore 23′ extends only to this external portion of valve element 15′.

Valve element 15′ has an enlarged shoulder section 65 with a surface in facing relation to a seat 53 forming a part of the housing 37′ internal structure. A sealing element comprising portions of shoulder section 65 and seat 53 or alternatively, an O-ring 62, may form a part of shoulder section 65 to provide for secure valve shutoff.

Diaphragm 50 is attached to the upper surface of valve element 15′ and to a projection 56 carried on valve element 15′. Again, the attachment between diaphragm 50 and projection 56 resists leakage of fluid in chamber 55. Diaphragm 56 flexes to allow axial translation of valve element 15′. Projection 56 may attach to an actuator that axially positions valve element 15′.

The lower portion of valve element 15′ has a cross section that matches the cross section of cavity 21′ and fits closely into cavity 21′. Valve element 15′ can shift axially within cavity 21′. The edge 29′ defines one end of the portion of aperture 18′ through which fluid can flow. As with the valve of FIGS. 3 and 4, the distance that aperture 18′ extends past edge 29′ of cavity 21′ determines the area of aperture 18′ through which fluid can flow. When valve element 15′ is shifted downwards as far as possible, O-ring 65 seals against seat 53 to oppose all fluid flow through valve 10′.

FIG. 7 shows a version of valve 10′ where O-rings 68 seal chamber 55, replacing the function of diaphragm 50.

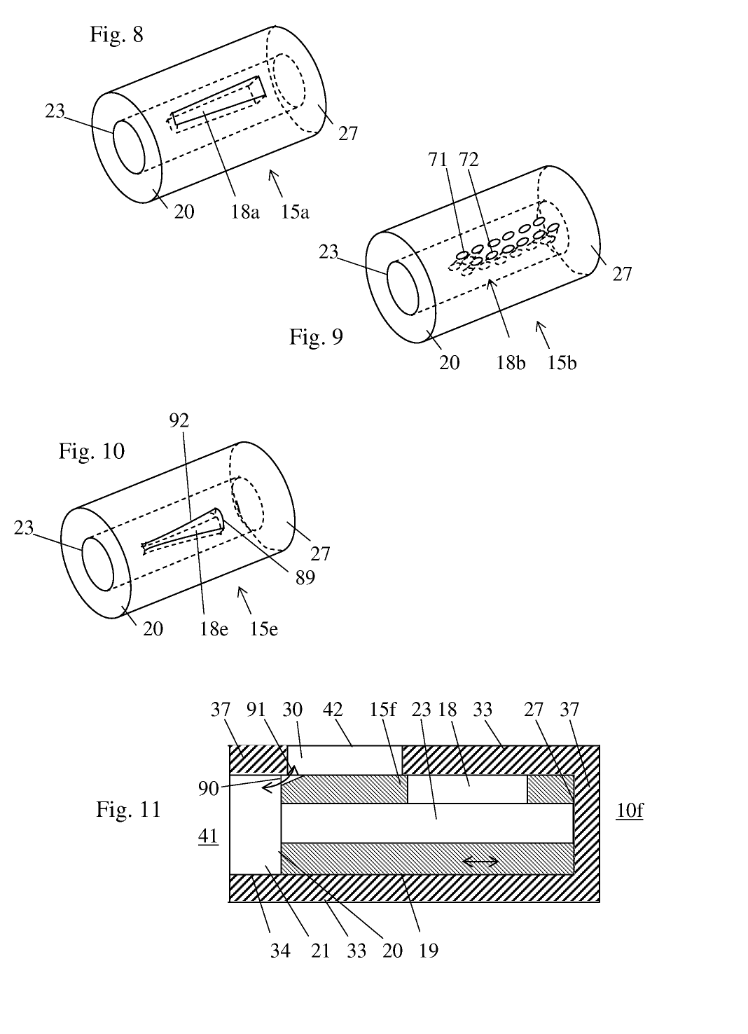

FIG. 8 shows a valve element 15a that can substitute for valve element 15 in FIGS. 1 and 2. Valve element 15a has an aperture 18a with a cross section substantially in the form of a trapezoid. As more and more of aperture 18a is exposed, a proportionately larger orifice forms that allows proportionately greater fluid flow.

FIGS. 9 and 10 also show valve elements that can substitute for valve element 15 in FIGS. 3 and 4. FIG. 9 shows a valve element 15b for use in a housing 37 as shown in FIGS. 3 and 4. Valve element 15b has two adjacent rows of small holes at 71 and 72 penetrating the annular wall of valve element 15b and that collectively comprise an aperture 18b. These holes provide fluid communication between bore 23 and the area external to valve element 15b. In a preferred embodiment, individual holes at 71 and 72 may be elliptical in cross section as shown with their major axes aligned with the axis of valve element 15b. The individual holes forming the row at 71 may be axially staggered with respect to the individual holes forming the row at 72. This design for aperture 18b may result in a flow rate that does not smoothly increase as more holes in the rows at 71 and 72 are exposed within gap 30.

FIG. 10 shows still another valve element 15e for use in the housing shown in FIGS. 3 and 4. Aperture 18e is similar to aperture 18a in valve element 15a of FIG. 8. However, the side walls 92 defining aperture 18e are slightly curved, so that a relatively small amount of area for fluid flow is exposed when a portion of the narrow (left) end of aperture 18e is within gap 30. The curved walls 92 of aperture 18e then create an area for fluid flow that, with leftward axial displacement of valve element 15e within bore 21 of housing 37, increases more rapidly than proportionally to the axial movement of element 15e.

In FIG. 10, end wall 89 in aperture 18e is shown as concave relative to the inside of the aperture 18e. Wall 89 may be blended with walls 92. When so blended, this feature avoids any corners in the aperture 18e that may induce cavitation or turbulence.

FIG. 11 shows a valve 10f as another version of valve 10 with a valve element 15f in bore 21. Valve element 15f has a feature 90 in the nature of a slot or chamfer intersecting the first end and the outer surface 19 thereof. Feature 90 provides for fluid flow as shown at 91 when aperture 18 is completely outside gap 30. In some circumstances a small amount of fluid flow at all times may be desirable, and feature 90 provides for such flow.

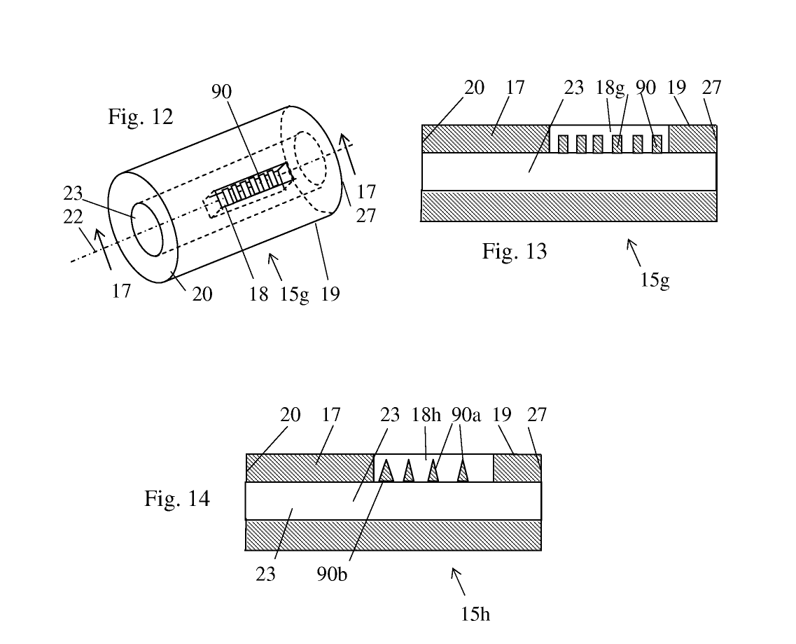

FIGS. 12 and 13 show a further version of a valve element 15g designed to axially slide in the bore 21 of housing 37, see FIGS. 3 and 4. Valve element 15g has a slot 18g with a number of bridges 90 transversely mounted across the width of slot 18g and defining a number of adjacent openings 91 between adjacent bridges 90 or between a bridge 90 and an end of slot 18g. The outer surface of each bridge 90 may be recessed from the extension of the valve element outer surface 15g.

Valve element 15g operates in a manner similar to that of valve element 15. The transverse bridges 90 improve the structural integrity of slots 18g and provide different flow rate characteristics as a function of element 15g position.

FIG. 14 shows further variations in the design of individual bridges 90a across a slot 18h. Bridges 90a have a non-rectangular cross section, shown as triangular in FIG. 14. A tapered or triangular cross section of bridges 90a may reduce turbulence of flow directed inwardly through slots 18h to bore 23.

FIG. 14 also shows a bridge 90b that has a cross section larger than that of bridges 90a. Low flow conditions maximize the pressure drop across slot 18h. A larger cross section can resist this greater pressure more effectively to prevent failure of bridge 90b under high pressure drops.

1. A metering valve comprising:
a) a substantially rigid housing having an internal cylindrical wall defining a cavity, and an opening at least one end of the cavity, and said housing having first and second chambers, wherein the first chamber is in flow communication with the housing's cavity at the opening thereof and wherein the second chamber is external to the cavity, said cylindrical wall having an edge defining at least a part of a flow space allowing fluid flow between the cavity and the second chamber; and
b) a substantially rigid valve element within the cavity, said valve element having first and second ends with a longitudinal axis extending therebetween and a cylindrical outer surface extending between the valve element's ends and whose shape and size substantially match that of the cavity's cylindrical wall, said valve element including i) a bore extending axially from the first end toward the second end, said bore in fluid communication with the first chamber of the housing, and ii) a metering aperture penetrating the valve element wall between the outer surface of the valve element and the valve element bore, said valve element shiftable within the housing cavity to a first position placing the edge within the metering gap at a first position to allow a first rate of fluid flow between the first chamber and the second chamber, and movable to a second position placing the edge within the metering aperture at a second position different from the first position to allow a second rate of fluid flow between the first and second chambers, wherein the flow has an axial component within the valve element bore and a radial component through the metering aperture.

2. The valve of claim 1, wherein an annular surface surrounds the cavity opening at the end thereof, the intersection of said annular surface with the cavity forming the edge.

3. The valve of claim 2, wherein the valve element has an annular shoulder in facing relation to the annular surface surrounding the cavity, and wherein one of the annular shoulder and the annular surface carries a sealing element.

4. The valve of claim 3, wherein the valve element's annular shoulder carries the sealing element.

5. The valve of claim 2, including a diaphragm attached to the housing at a periphery of the diaphragm and centrally to the valve element, said diaphragm defining a portion of the second chamber.

6. The valve of claim 2 wherein the housing includes an interior cylindrical bore spaced from and aligned with the cavity and surrounding the valve element, and including a seal closing the flow space between the internal cylindrical bore and the valve element.

7. The valve of claim 1, including a diaphragm whose center is sealingly attached to the second end of the valve element and whose periphery is sealingly attached to the housing.

8. The valve of claim 1, wherein the housing has an opening therein extending from the second chamber to the cavity with flow communication between the first and second chambers through the cavity and the opening, said opening spaced from the first chamber and axially defined at an end thereof by the edge.

9. The valve of claim 1, wherein non-parallel sides extending along the valve element's longitudinal axis define the metering aperture.

10. The valve of claim 1, wherein curved sides generally extending along the valve element's longitudinal axis define the metering aperture.

11. The valve of claim 1, wherein a series of openings in the valve element aligned along the longitudinal axis of the valve element forms the metering aperture.

12. The valve of claim 11, wherein bridges transverse to said longitudinal axis define the series of openings along the longitudinal axis of the valve element.

13. The valve of claim 12, wherein at least one of the bridges has an interior surface in substantial alignment with the surface defining the valve element's bore, and an exterior surface recessed from the adjacent valve element exterior wall.

14. The valve of claim 13, wherein at least one of the bridges has a tapered cross section.

15. The valve of claim 11, wherein the spacing between a first pair of adjacent ones of the openings is different from the spacing between a second pair of adjacent ones of the openings

16. The valve of claim 1, wherein a series of openings in the valve element spaced transversely to the longitudinal axis of the valve element forms the metering aperture.

17. The valve of claim 16, wherein the series of openings are spaced along the longitudinal axis of the valve element.

18. The valve of claim 1, wherein the valve element includes a feature intersecting the first end and the outer surface, said valve element having a position aligning a portion of the feature with the housing's flow space, and allowing fluid flow when in said position.
